(19) United States
(12) Patent Application Publication
(10) Pub. No.: US 2003/0225547 A1
(43) Pub. Date: Dec. 4, 2003

(54) Wireless feeder verification system

(75) Inventor: James I. Paradies, Clintondale, NY (US)

Correspondence Address: Ira D. Blecker, Intellectual Property Law, IBM Corporation, Dept. 18G, Building 300-482, 2070 Route 52, Hopewell Junction, NY, 12533, US

(73) Assignee: International Business Machines Corporation, Armonk, NY

(21) Appl. No.: 10/159,922

(22) Filed: May 30, 2002

(51) Int. Cl. G06F 15/00

(52) U.S. Cl. 702/150

(57) ABSTRACT

A system and a method for verifying the correct placement of feeders in automated placement machines. The system includes a general purpose computer having a visual display and a software application which processes identification information scanned by the handheld wireless identification reader and compares the identification information to a feeder list. The software application then provides instructions on the visual display to the operator. If the previously scanned feeder is determined by the verification program to be in the correct slot the program instructs the operator to proceed to and scan the next feeder. If the previously scanned feeder is determined by the verification program not to be in a correct slot then the verification program alerts the operator to the error and prevents the operator from proceeding to the next feeder until the determination of the previous feeder is corrected.

### BACKGROUND OF THE INVENTION

The invention relates to the automatic placement of electronic components onto circuit boards or chip carrier substrates. More particularly, the invention relates to a system and a method for verifying that an automated electronic component placement machine is correctly configured prior to operation.

In the electronics industry, high speed automated placement machines are often used to place electronic components on printed circuit boards or individual chip carrier substrates. Such machines typically utilize many different electronic component feeder magazines arranged in a predetermined order to achieve a high assembly rate. It is critical that the correct electronic component be loaded in each component feeder magazine and that each component feeder magazine be loaded in the correct sequence on the placement machine.

To perform automatic placement at high production rates the placement machine feeder magazine configuration must be correct. Manual verification of the multiple component feeder magazines, to confirm that the correct electronic component is loaded in each component feeder magazine, is time consuming and prone to human error. Failure to verify the component feeder configuration before the assembly operation creates the risk of producing a large number of defective assemblies before the error can be discovered and corrected.

The present invention is a system and a method which supports a manufacturing process for “feeder verification”. As indicated, and for the purpose of this invention “feeders” are mechanical holders of electronic components, such as capacitors or resistors, that are placed on circuit boards or chip carrier substrates by placement machines. Feeders are loaded or plugged into numbered positions or “slots” on the placement machine. Verification of these feeders is typically a manual process whereby a machine operator, i.e., a human being, verifies that they have the correct components in the correct feeders in the correct slots on the machine. This verification is performed by eye. Often it takes two people, one to read a component part number and the other person to confirm the validity of that information using a feeder list which contains the desired placement of components on the feeder.

There are several problems with manual verification. The process is slow and increases production cycle time. Another problem is access by the operator to the placement machine. Placement machines are very large and typically require about 4 feet or more of walking space around them. There is no way to access them with a scanning system that is connected to a computer by a wire. Another common problem is swapping two feeders, or putting a component feeder in the wrong slot. The current solution to this problem requires expensive “smart” feeders. These electronic “smart” feeders contain a logic chip which, if programed correctly, will either prevent the loading of a feeder in a wrong slot or reconfigure the placement sequence to correct the error. These can cost millions of dollars to purchase and implement, but can help ensure the component feeders are positioned on the placement machines correctly. They do so by forcing the machine operator to program the component number into the electronic feeder. These “smart” feeders will communicate with the placement machine and tell it what component it contains.

These automated smart feeders have their own problems. A major problem with the current systems is cost. Automated feeder verification systems are very expensive. The best of these are licensed by machine. Many companies have found the costs are too high to implement. This leads to another problem with the current process options, which is inconsistent solutions. The current smart feeders are a machine specific solution where the company that makes the placement machine offers the software verification system. The primary problem with this solution is that their software will only work on their machine. This leads to the problem of multiple processes discussed above. In addition, they can also be very expensive to maintain. Many companies choose a manual method in order to avoid the cost of a license for each placement machine and the added expense of buying special hardware for each machine specific verification system.

Many companies will have more than one type of placement machine. In these cases, they will not be able to implement one common method of verifying feeders. They will typically implement a mix of manual and automated systems, with different automated systems required for different tools. This can lead to multiple processes with the accompanying problems of increased training costs and increased possibilities for human error. These errors represent one of the biggest problems with the conventional methods. Human errors cause scrap, rework, and lower productivity.

Many companies are looking for a uniform solution but have not implemented one due to cost concerns. It is simply less expensive to have the machine operator verify the feeder setup manually and take the risk of human error. Therefore there is a need for a lower cost alternative to the current automated systems.

There are a number of solutions proposed by others for calibrating and verifying automated placement tools. Campbell et al. U.S. Pat. No. 6,202,031, the disclosure of which is incorporated by reference herein, discloses a method for calibrating an automated machine having a robotic arm for picking up components which are to be retrieved for placement directly from a shipping tray. The disclosure is directed to assuring that the arm moves to the correct spatial coordinates and does not address the problem of verifying that the tray contains the proper components.

Helsley U.S. Pat. No. 5,730,299, the disclosure of which is incorporated by reference herein, discloses an automation and verification device for an insert machine which assembles stacks of inserts. This is a mechanical system which compares automated scanner input from a hopper and stops the machine if an error is detected.

Rezaei U.S. Pat. No. 5,325,305, the disclosure of which is incorporated by reference herein, discloses an automated setup verification system for verifying that the electronic component feeder magazines are correctly installed. This is a large mechanism that moves the barcode scanner along an axis in order to scan specially designed feeders.

Notwithstanding the prior art solutions to the problem, there remains a need for a low cost, wireless method which is adaptable to any feeder design. Accordingly, it is a purpose of the present invention to provide a system and a method that allows an operator to remotely scan the feeders. It presents the operator with a large visual image of the feeder they need to scan and manages the process of verifying each feeder.

It is another purpose of the present invention to provide a verification solution which is very fast. The design of the present system and method allows the machine operator to quickly scan each feeder one time and then exit thereby drastically reducing verification time.

It is another purpose of the present invention to improve access to the placement tool. Because the scanner is wireless, the machine operator can walk all around a large placement machine thereby greatly improving operator access to the machine.

It is another purpose of the present invention to reduce cost. The present system and method would be a low cost alternative and can be used with a variety of placement machines.

It is another purpose of the present invention to provide a consistent solution. The present system and method will work with any placement machine, thereby allowing a company with several different placement tools to implement one system.

These and other purposes of the present invention will become more apparent after referring to the following description considered in conjunction with the accompanying drawings.

### BRIEF SUMMARY OF THE INVENTION

The purposes and advantages of the present invention have been achieved by providing a system and a method for verifying the correct placement of feeders in automated placement machines. The system includes an automated placement machine for the automated placement of components such as capacitors or resistors. The placement machine has multiple slots on one or more sides. The slots are loaded with feeders containing the components to be placed by the placement machine. The feeders are also labeled with an identification symbol such as a barcode. A handheld wireless identification reader is used to remotely scan the identification symbol on each feeder.

The system also includes a general purpose computer having a visual display. A scanner base receiver is in communication with the computer and receives the information scanned by the handheld wireless identification reader. The computer also has a verification program which processes identification information scanned by the handheld wireless identification reader and compares the identification information to a feeder list. The verification program then provides instructions on the visual display. If the previously scanned feeder is determined by the verification program to be in the correct slot the program provides instructions to proceed to and scan the next feeder. If the previously scanned feeder is determined by the verification program not to be in a correct slot then the verification program provides instructions to take corrective action. The verification program will not accept identification information from any subsequent feeders until the determination of the previous feeder is corrected.

The invention also consists of a method for verifying the correct placement of feeders in automated placement machines comprising the steps of:

providing a placement machine having a plurality of slots containing feeders, the feeders containing components to be placed on a board or card by the placement machine;

providing a general purpose computer which has a visual display;

accessing a software verification program on the computer;

selecting a placement machine identification in the verification program;

selecting a feeder list in the verification program;

providing a handheld wireless identification symbol reader;

providing a scanner base receiver in communication with the computer;

scanning the first feeder on the placement machine, the first feeder having an identification symbol;

comparing the identification information of the first feeder with the feeder list; and

viewing the visual display where the software verification program will display instructions to either i) scan the next feeder on the placement machine if the first feeder is located in a correct slot on the placement machine, or, ii) stop and correct the incorrect placement of the first feeder.

The method further comprises the steps of:

scanning a second feeder on the placement machine, the second feeder having an identification symbol;

comparing the identification information of the second feeder with the feeder list;

viewing the visual display where the software verification program will display instructions to either i) scan the next feeder on the placement machine if the second feeder is located in a correct slot on the placement machine, or, ii) stop and correct the incorrect placement of the second feeder; and

repeating the previous three steps until all feeders are scanned and correct feeder placement achieved.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a schematic representation of a wireless feeder verification system in accordance with the invention.

FIG. 2 is a flow chart of a preferred embodiment of the present invention.

### DETAILED DESCRIPTION OF THE INVENTION

The purposes of the present invention have been achieved by providing a system and a method that supports a manufacturing process known as “feeder” verification. As discussed earlier feeders are mechanical holders of electronic components, such as capacitors, which are placed on circuit boards or chip carrier substrates by placement machines. Feeders are plugged into numbered “slots” on the placement machine. Verification of these feeders is typically a manual process whereby a machine operator verifies that they have the correct components in the correct feeders in the correct slots on the machine. This verification is typically performed by an operator by eye.

The most common errors made by machine operators is to misread the number printed on the feeder. A common error, for example, would be to substitute an incorrect number such as 02H3287 for the correct number 02N3287. The present invention includes a system that collects the information with a wireless handheld scanning device, transmits the information to a scanning receiver connected to a computer, and a software verification program that ensures that the feeder which is scanned is read and positioned correctly.

The invention solves the problem of misidentification and incorrectly located components by requiring that the scanning be done in sequence. In other words, the solution will require the feeder in slot one to be scanned first. Once the first feeder has been scanned and verified, the solution requires the feeder in slot two to be scanned. This way, a swapped or misplaced feeder will be detected. This solution is very inexpensive compared to the costs associated with electronic “smart” feeders.

The software verification program is installed and run at the users production facility. It can support a variety of different placement machines. The software verification program can be written in any suitable medium. In a preferred embodiment it is written in java and is a java applet that allows the machine operator to remotely scan the feeders. The computer system is any general purpose computer, such as a conventional personal computer (PC). In a preferred embodiment the PC is connected to a local area network. The operator uses a graphic user interface (GUI) at the start of the process to identify who they are, and what machine/program they are setting up. The system includes a visual display or monitor which presents the operator with a large visual image of the feeder they need to scan and manages the process of verifying each feeder.

In a preferred embodiment the network can run a version of Netscape or MS Internet Explorer that supports java 1.1.8 or higher. Any relational database will do. In a preferred embodiment the server has IBM DB2 and a service for java applets, although DB2 is not a requirement. The only other requirement for a preferred web embodiment would be an http web server. In a preferred embodiment apache is installed on the same server as the database. Here again, this is not a requirement. Any web server configuration will do. If the software verification program were to be installed somewhere else, it would simply need a server side installation procedure to be written.

The system employs a production operator who walks around a placement machine and manually scans the identification symbol on each component with a wireless handheld scanner. A scanner base receiver is connected to the computer. The scanner base receiver receives the scan from the wireless handheld scanner and transmits the component identification information to the computer verification program. This can be accomplished in several ways well known in the art. In one embodiment the scanner base receiver is plugged in series with the computer keyboard. The verification program creates a data entry field which receives the scan just as it would receive a keyboard entry. In a preferred embodiment the verification program will ensure the barcode information was not typed from the keyboard or pasted into the field. Typical methods to accomplish this include checking the time between which character information in received.

In another embodiment the scanner base receiver is plugged into the computer communications port. The verification program includes code to support two way audio communications with the wireless handheld scanner. As an example, if the bar code information received is verified, a single audible “beep” response is sent back to the handheld scanner and is heard by the operator. If the bar code information received is not verified, then 3 audible beeps are sent back to the handheld scanner and is heard by the operator.

Using these methods the verification program receives the input and compares the barcode information to a feeder list. It then provides visual and/or audible instructions to the operator. If the correct feeder is located in the correct slot the verification program indicates that the operator can proceed to the next feeder. If the feeder is incorrectly located then the verification program instructs the operator stop and fix the incorrect feeder. The verification program will not accept input for any subsequent feeders until the present feeder is verified. The system software/user interface controls the process of feeder verification. The system is low cost and is not wired into a placement machine in any way. The system allows the operator to walk freely around all sides of a placement machine. The system scans the barcode on the component reel itself and will work with any feeder design. A log record is created automatically in the database at the end of the verification process.

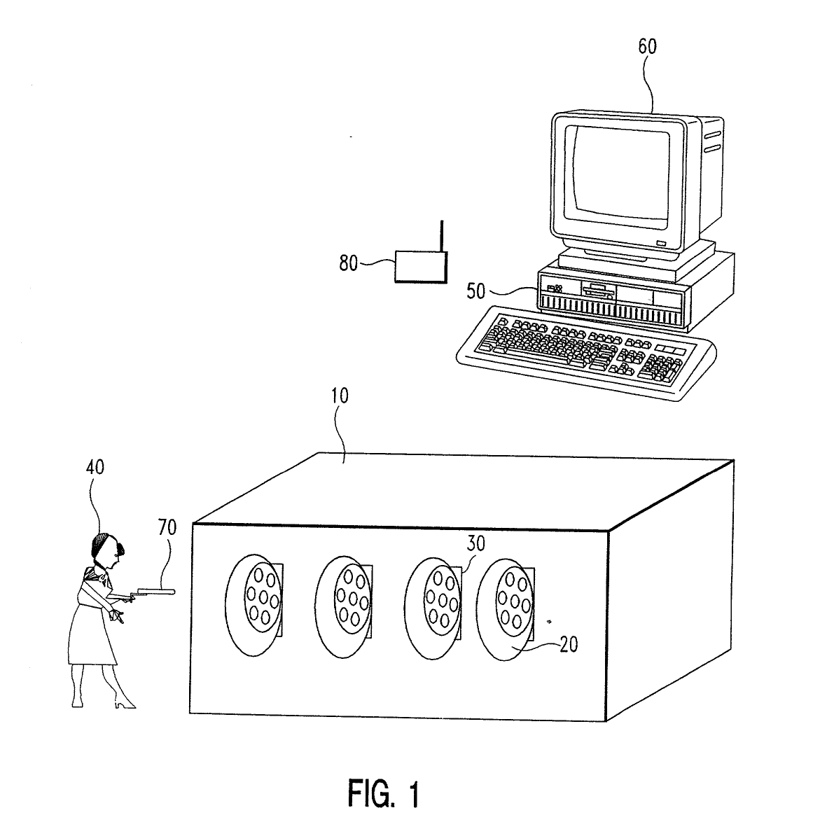

Referring now to FIG. 1 there is shown an illustrative wireless feeder verification system according to the present invention. An automated placement machine 10 has feeders 20 located in slots 30 on the side of the machine. The feeders 20 contain components, not shown, which may be capacitors, resistors or any component which is to be attached to an electronic circuit board or chip carrier substrate. The feeders 20 are typically reels as shown in FIG. 1 which contain tape which holds the components. However, the feeder 20 may also be a tray or any container which can hold components and is adaptable to the automated placement machine 10.

The slots 30 are typically rails which protrude from the side of the placement machine 10, however they may also be shelves or any receptacle which is designed to hold the feeder 20 and is compatible with the particular placement machine. A typical placement machine 10 will have a plurality, or row of slots 30 located on a side. In addition, a typical placement machine 10 will have a row of slots 30 on two or more sides. A given circuit board or chip carrier may require a variety of different components. A typical placement machine 10 will have a plurality of slots 30 loaded with a plurality of different feeders 20 containing different components.

According to the present invention, once all the required slots are loaded with feeders for a given job, a human operator 40 will access a general purpose computer 50 having a visual display 60. The operator 40 will start a verification program and enter the identification of the placement machine 10 being verified or select the placement machine from a menu. In a preferred embodiment the computer 50 is connected to a local area network capable of supporting Internet access. The operator then identifies or selects the “feeder list” for the placement machine 10 to be verified. A “feeder list” is the name given to the list of all the various feeders 20 containing the components to be placed and their intended slot 30 position on the placement machine 10. The verification program will then prompt the operator 40 to begin the verification process.

The operator 40 will take a wireless handheld scanning device 70 for scanning identification symbols such as linear bar codes or two dimensional matrix identification symbols. A scanner base receiver 80 is in communication with the computer 50. Each feeder 20 will have an identification symbol, such as a barcode. The operator 40 will scan the symbol of the feeder positioned in the first slot using the wireless handheld scanning device 70 and this scan information will be transmitted to the scanner base receiver 80. The scanner base receiver 80 will transmit the scan information to the computer 50.

The operator will also view the visual display 60 which is preferably positioned such that the operator 40 can view it from any side or position along the perimeter of the placement machine 10. The verification program will compare the scanned information identifying the feeder 20 and compare it to the reference information contained in the feeder list. If the scanned feeder identification matches the reference information contained in the feeder list the operator is prompted to continue and scan the next feeder. If the scanned feeder identification does not match the reference information contained in the feeder list the verification program will indicate the error and not allow the operator to input any subsequent feeder scans.

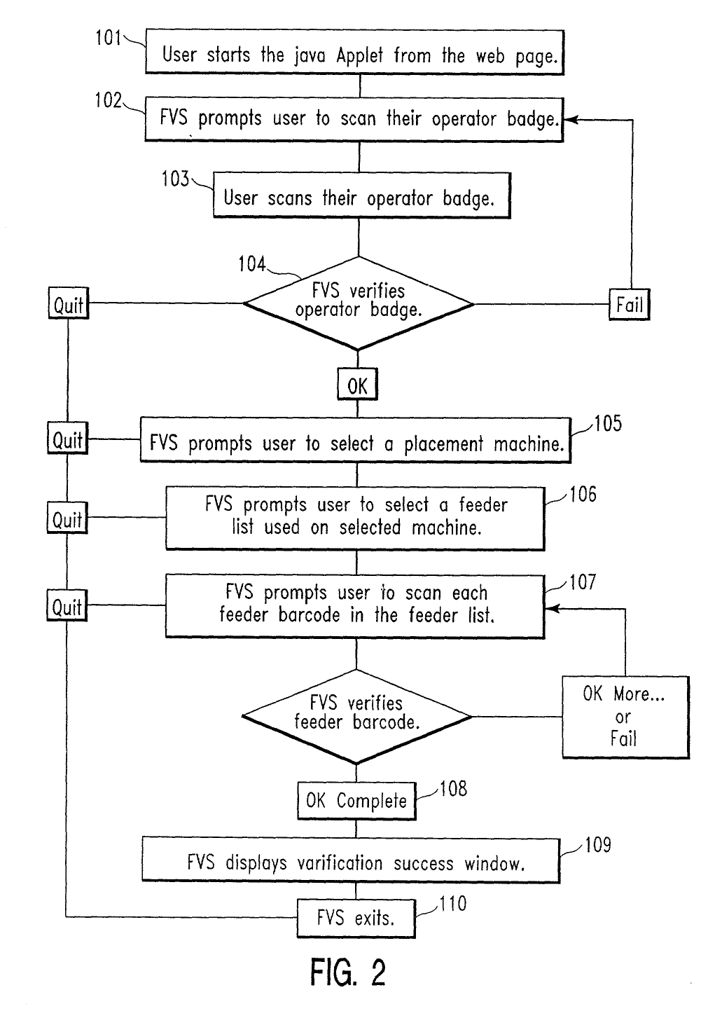

Referring to FIG. 2 there is shown a flowchart representing a preferred embodiment of the present invention. In step 101 the operator starts the feeder verification software (FVS). In a preferred embodiment the operator starts a JAVA Applet from a web page supported by the local area network connected to the computer. Next, in step 102 the verification program software prompts the operator to enter an operator identification in order to access the verification program. The operator may enter or select an identification, or in a preferred embodiment as shown in step 103, the operator uses the wireless handheld scanner to scan an identification badge.

In step 104 the verification program software verifies the operator's identification and then in step 105 the verification program software prompts the operator to identify or select from a menu the placement machine to be verified. Once the placement machine is identified, then in step 106 the verification program software prompts the operator to identify or select from a menu the feeder list associated with the placement machine to be verified. The verification program will then confirm the correct feeder list is associated with the correct placement machine.

If this pairing is correct, in step 107 the verification program will prompt the operator to scan a feeder in the first slot. If the scan information associated with that slot position matches the information on the feeder list the operator is prompted to scan another feeder in the next slot. However, if the scan information does not match, the operator is alerted to the error and cannot continue to scan the next slot until the error is corrected. The operator must load the correct feeder in the slot and have the verification program confirm the new scan before proceeding to the next slot.

In this way the operator scans each feeder in each slot, starting with a first designated slot and progressing around the placement machine until the last required feeder has been scanned and approved by the verification program as shown in step 108. Once the last feeder in the feeder list has been confirmed the verification program, as shown in step 109, will display a “success” window to alert the operator that the placement machine verification is complete. In step 10 the verification program will then prompt the operator to exit the program.

In one embodiment large colored symbols, such as green for continue and red for stop are used to prompt the operator 40. In another embodiment audio signals such as beeps can also be used to alert the operator 40 to the result of the scan. In a typical placement operation a single operator 40 will be able to scan each feeder 20 in sequence, circumventing each side of the placement machine 10 while they monitor the visual display 60. This solution to the problem of feeder verification is very fast. The design of the software allows the machine operator to quickly scan each feeder one at a time and then exit, thereby reducing verification time. Current verification methods often require two operators, one to read a feeder part number and the other to confirm the validity of that information using a feeder list. This system eliminates the need for two operators.

In addition, the verification program eliminates the possibility of human error which can result in scrap, rework, and lowers productivity. A common problem in manual verification is misreading an identification number printed on a feeder. The present system would detect that and not allow the operator to continue until the correct number has been scanned. Other common errors include swapping two feeders or putting a component feeder in the wrong slot. The present system ensures that a scanned feeder is identified if improperly loaded in the incorrect slot.

The use of a wireless handheld scanning device also solves the problem of access. Placement machines are very large and often require more than 4 feet of walking space around them. There is no way to conveniently access them with a scanning system that is connected to a computer by a wire. Because the scanner in the present system is wireless, the operator can walk all around a large placement machine. The only requirement is to be able to see the computer visual display monitor, or in an audio embodiment, to hear the program signals.

The present invention also solves the problem of inconsistent solutions for users who have more than one type of placement machine. In many cases they will not be able to implement one common method of verifying feeders. The present invention provides a consistent solution by using verification program software which will work with any general purpose computer and can be used with any placement machine installed in proximity to the computer.

The current invention is also a low cost alternative to automated, licensed feeder verification systems which are only compatible with a particular placement machine.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A system for verifying the correct placement of feeders in automated placement machines comprising:
an automated placement machine for the automated placement of components, said placement machine having a plurality of slots, at least one slot containing a feeder, said feeder containing components to be placed by said placement machine, and said feeder having an identification symbol;
a handheld wireless identification reader to remotely scan said identification symbol on said at least one feeder;
a general purpose computer, said general purpose computer having a visual display;
a scanner base receiver in communication with said computer; and
a verification program which receives identification information scanned by said handheld wireless identification reader and compares the identification information to a feeder list, said verification program then providing instructions on said visual display to proceed to the next feeder if the identification information agrees with the feeder list, or stop and take corrective action if the identification information does not agree with the feeder list.

2. The system of claim 1 wherein said identification symbol is a linear barcode.

3. The system of claim 1 wherein said identification symbol is a two dimensional matrix identification symbol.

4. The system of claim 1 wherein said general purpose computer is connected to a local area network

5. The system of claim 4 wherein said local area network supports an Internet application.

6. The system of claim 5 wherein said verification program is a JAVA Applet.

7. The system of claim 1 wherein said feeder is a reel.

8. The system of claim 1 wherein said feeder is a tray.

9. The system of claim 1 wherein said scanner base receiver is connected to a computer keyboard.

10. The system of claim 1 wherein said scanner base receiver is in communication with a communications port of said computer, said communications port providing audio signals to proceed to the next feeder if the identification information agrees with the feeder list, or stop and take corrective action if the identification information does not agree with the feeder list.

11. A method for verifying the correct placement of feeders in automated placement machines comprising the steps of:
providing a placement machine having a plurality of slots containing feeders, said feeders containing components to be placed by said placement machine;
providing a general purpose computer, said computer having a visual display;
accessing a software verification program on said computer;
selecting a placement machine identification in said verification program;
selecting a feeder list in said verification program;
providing a handheld wireless identification symbol reader;
providing a scanner base receiver in communication with said computer;
scanning a first feeder on said placement machine with said handheld wireless identification symbol reader, said first feeder having an identification symbol;
comparing the identification information of the first feeder with said feeder list; and
viewing said visual display where said software verification program will display instructions to either i) scan the next feeder on said placement machine if said first feeder is located in a correct slot on said placement machine, or, ii) stop and correct the incorrect placement of said first feeder.

12. The method of claim 11 further comprising the steps of:
scanning a second feeder on said placement machine, said second feeder having an identification symbol;
comparing the identification information of said second feeder with said feeder list;
viewing said visual display where said software verification program will display instructions to either i) scan the next feeder on said placement machine if said second feeder is located in a correct slot on said placement machine, or, ii) stop and correct the incorrect placement of said second feeder; and
repeating the previous three steps until all feeders are scanned and correct feeder placement achieved.

13. The method of claim 11 wherein said computer is connected to a local area network.

14. The method of claim 13 wherein said computer supports an Internet application.

15. The method of claim 14 wherein said verification program is a JAVA Applet.

16. The method of claim 11 further comprising the step of entering an operator identification into said verification program prior to said step of selecting a placement machine identification.

17. The method of claim 11 wherein said identification symbol is a linear barcode.

18. The method of claim 11 wherein said identification symbol is a two dimensional matrix identification symbol.

19. The method of claim 11 wherein said feeder is a reel.

20. The method of claim 11 wherein said scanner base receiver is in communication with a communications port of said computer, said communications port providing audio signals to either i) scan the next feeder on said placement machine if said first feeder is located in a correct slot on said placement machine, or, ii) stop and correct the incorrect placement of said first feeder.
